(19) United States
(12) Patent Application Publication
(10) Pub. No.: US 2008/0225310 A1
(43) Pub. Date: Sep. 18, 2008

(54) Data processing using print driver

(75) Inventor: Hung Khei Huang, Irvine, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/724,442

(22) Filed: Mar. 15, 2007

(51) Int. Cl. H04N 1/60

(52) U.S. Cl. 358/1.9

(57) ABSTRACT

The present invention provides for transforming a document containing data using a filter pipeline. The document is received, and at least one parameter for transforming the data within the document is obtained by a print driver interface. The data within the document is transformed based on the obtained at least one parameter, using the filter pipeline. The transformed document is output. As such, an enhancement/transformation feature can be applied to data within a document from virtually any editing software application, even if that application does not incorporate the feature into its software.

### BACKGROUND OF THE INVENTION

1. Field of the Invention

The invention relates to the field of data processing, and more particularly relates to transforming data within a document using a print driver.

2. Description of the Related Art

Electronic documents typically include image data and/or text data, and it is often desired to transform that data. For example, in the field of digital photography, one may wish to perform photo enhancement or transformation of images within a document. In another example, it may be desired to process text within a document, such as performing a spell-check and correction of misspelled text.

In this regard, different software packages have different capabilities for transforming data. For example, photo editing software typically includes numerous features for image processing, while word processing software typically includes features for text processing.

However, if a user wants to access particular enhancement/transformation features, the user is typically bound to a software package which offers those features. In other words, the user is typically not able to access enhancement/transformation features in an editing software package or application which does not incorporate those features.

### SUMMARY OF THE INVENTION

In view of the foregoing problems, the present invention provides for transforming a document containing data using a filter pipeline. A print driver interface obtains at least one parameter for transforming the data within the document. The filter pipeline transforms the data within the document based on the obtained at least one parameter. As such, an enhancement/transformation feature can be applied to data within a document from virtually any editing software application, even if that application does not incorporate the feature into its software.

According to one aspect of the invention, the transforming of a document containing data using a filter pipeline is provided. The document is received, and at least one parameter for transforming the data within the document is obtained by a print driver interface. The data within the document is transformed based on the obtained at least one parameter, using the filter pipeline. The transformed document is output.

The filter pipeline can execute at least one filter for transforming the data within the document based on the obtained at least one parameter. The filter pipeline can be a Microsoft Vista® filter pipeline. The at least one filter can use an IXpsDocumentProvider Interface, which is included within the MS Vista® filter pipeline, to access the obtained at least one parameter and to access the document containing the data.

The print driver interface can be a user interface configured to obtain the at least one parameter from a user. The document can be received as an XML Page Specification (XPS) document. Alternatively, the document can be received as a non-XPS document, which is converted to an XPS document before being transformed. The transformed document can be output as an XPS document.

The data within the document can be image data, with the at least one filter being an image transformation filter. The data within the document can also be text data, with the at least one filter being a text transformation filter.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a representative view of a computer system in which the present invention may be implemented.

FIG. 2 is a block diagram depicting an example of an internal architecture of the FIG. 1 embodiment.

FIG. 3 is a block diagram depicting a print system which includes a print driver for transforming a document containing data, according to a representative embodiment of the invention.

FIG. 4 is a flowchart illustrating transformation of a document containing data, according to a representative embodiment of the present invention.

### DETAILED DESCRIPTION OF THE INVENTION

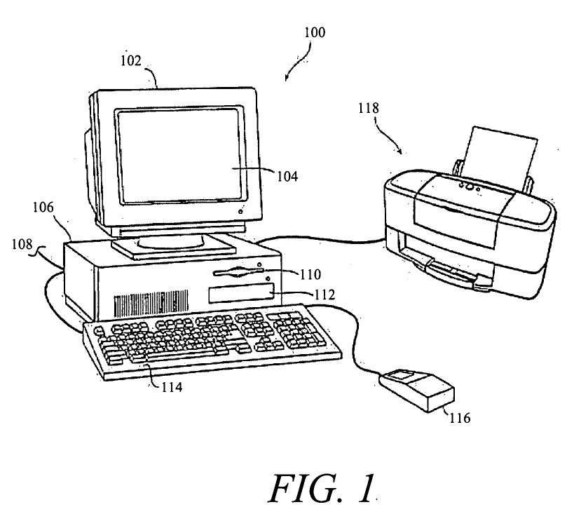

Referring to FIG. 1, a representative view of the outward appearance of a representative computing system including computing equipment, peripherals and digital devices which may be used in connection with the practice of the present invention is shown. Specifically, FIG. 1 depicts computing equipment 100, which includes host processor 106 comprising a personal computer (hereinafter “PC”). Provided with computing equipment 100 are monitor 102 including display screen 104 for displaying text and images to a user, keyboard 114 for entering text data and user commands into PC 106, and pointing device 116. Pointing device 116 preferably comprises a mouse, for pointing, selecting and manipulating objects displayed on display screen 104.

Computing equipment 100 includes a computer readable memory medium such as computer fixed disk 112 and/or removable memory media drive 110. Removable memory media drive 110 provides a means whereby computing equipment 100 can access information, computer-executable process steps, application programs, etc. stored on removable memory media.

Also included is printer 118, which forms printouts on a recording medium such as paper or transparencies or the like. Printer 118 receives data for printing from PC 106.

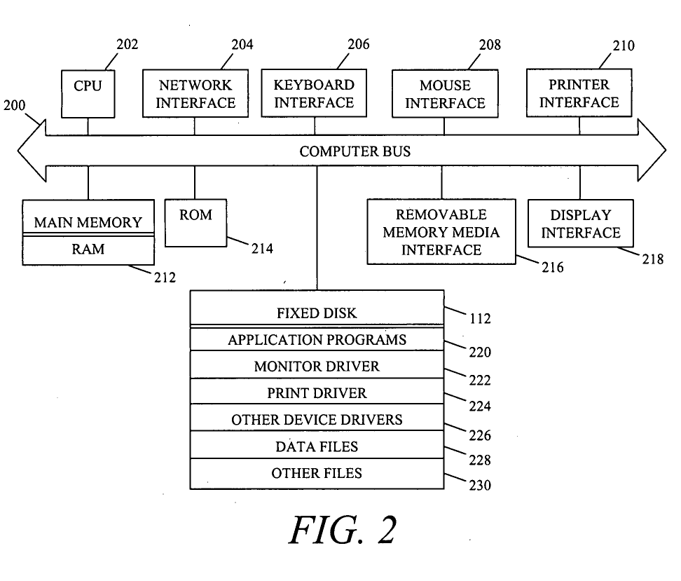

FIG. 2 is a block diagram illustrating the internal architecture of the FIG. 1 embodiment. As shown in FIG. 2, PC 106 includes network interface 204 for network access 108, and central processing unit (“CPU”) 202, that interfaces with computer bus 200. Also interfacing with computer bus 200 are fixed disk 112, random access memory (“RAM”) 212 for use as main memory, read only memory (“ROM”) 214, removable memory media interface 216 to allow PC 106 to interface with removable memory media drive 110, display interface 218 for interfacing with monitor 102, keyboard interface 206 for interfacing with keyboard 114, mouse interface 208 for interfacing with pointing device 116, and printer interface 210 for interfacing with printer 118.

Main memory 212 interfaces with computer bus 200 so as to provide quick RAM storage to CPU 202 during execution of software programs such as the operating system application programs, and device drivers. More specifically, CPU 202 loads computer-executable process steps from fixed disk 112 or other memory media into a region of main memory 212 in order to execute software programs. Data such as document data can be stored in main memory 212, where the data can be accessed by CPU 202 during execution.

Read only memory (ROM) 214 stores invariant computer-executable program code, or program or process steps, for basic system functions such as basic input and output (I/O), startup, or reception of keystrokes from keyboard 114.

As also shown in FIG. 2, fixed disk 112 stores computer-executable code for application programs 220, monitor driver 222, print driver 224, other device drivers 226, data files 228 and other files 230.

Print driver 224 is software that converts data to a form that can be printed by printer 118. In one representative embodiment, print driver 224 is configured to perform transformation of a document containing data, where the transformed document can be used for further processing, viewing or printing.

FIGS. 1 and 2 illustrate one example of a computing system that executes program code, or program or process steps, configured to perform perform transformation of a document containing data. However, it should be noted that other types of computing systems may also be used.

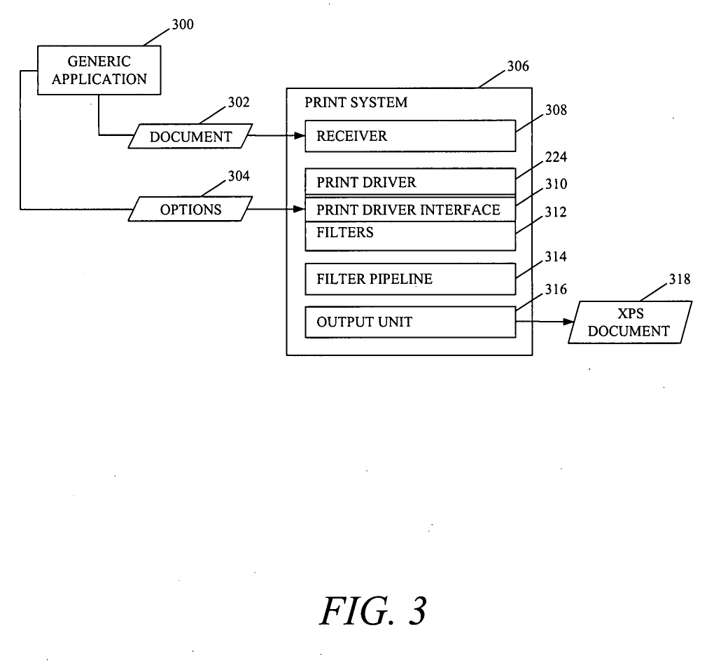

FIG. 3 is a block diagram depicting a print system 306 which includes a print driver 224 for transforming a document containing data, according to a representative embodiment of the invention. The print system 306 also includes a receiver 308, a filter pipeline 314 and an output unit 316.

For example, print system 306 can correspond with the MS Vista® filter pipeline architecture, which is a print subsystem. This embodiment can use the MS Vista® filter pipeline architecture to make enhancement/transformation features available to virtually any application installed in MS Vista®.

The enhancement/transformation features are preferably implemented as filters 312 within print driver 224, where filters 312 are used by filter pipeline 314. The output (e.g., enhanced/transformed documents) of print system 306 is preferably an XPS document 318 which can be used for further processing, viewing or printing.

More specifically, receiver 308 of print system 306 receives a document 302 containing data from a generic application 300. Document 302 can be received by receiver 308 as an XPS document. Alternatively, document 302 can be received from generic application 300 as a non-XPS document, which is in turn converted within print system 306 into an XPS document for use by print driver 224.

Print driver 224 includes a print driver interface 310 which receives one or more options 304 as input, where the one or more options 304 correspond to one or more parameters for transforming document 302. Print driver interface 310 may be invoked by generic application 300.

Furthermore, print driver interface 310 can be a user interface, which is accessed by a user of generic application 300 to set options 304. Alternatively, printer driver interface 310 can be non-user based, where options 304 are obtained by accessing data from a source other than a user, such as a data file. As noted above, the options 304 correspond to parameters for effecting enhancement/transformation of data within document 302.

In this regard, transformation of data within document 302 preferably occurs as follows. Print system 306 invokes filter pipeline 314, when document 302 is sent to a printer corresponding to print system 306. Filter pipeline 314 invokes and executes filters 312, which are included in print driver 224, to transform the data of document 302. Filters 312 call filter pipeline 314 to get document 302, and filter pipeline 314 sends document 302 to filters 312. Filters 312 transform the data of document 302, based on the parameters corresponding to options 304. Filter pipeline 314 receives output from filters 312, where the output corresponds to the transformed document. In this regard, it should be noted that although filter pipeline 314 is depicted separate from print driver 224, filter pipeline 314 may be integrated within print driver 224.

Print system 306 also includes output unit 316, which outputs the transformed document as XPS document 318. XPS document 318 can be used for further processing, viewing or printing.

In a case where MS Vista® filter pipeline architecture is used, filters 312 within print driver 224 preferably use the IXpsDocumentProvider Interface. In particular, the IXpsDocumentProvider interface includes a PrintTickets function which can be used to retrieve the parameters for transforming document 302. IXpsDocumentProvider interface also includes a FixedPages function which can be used to locate data within document 302 via a FixedPage contents parameter (or a via FixedPage.rels parameter, which has a list of all the resources present in the page) and to perform the desired enhancement/transformation on the located data.

There are different types of enhancement/transformation features which can be applied to the data of document 302. For example, in the field of digital imaging, one may wish to perform enhancement or transformation of images within a document. In this case, possible enhancement/transformation features include, but are not limited to, the following:
1) Picture enhancement filter (e.g., improve brightness, contrast);
2) Color Enhancement filter (e.g., perform color matching);
3) Effect filter (e.g., convert document from color to GrayScale, apply special effects to the image elements, etc.);
4) Economy (draft) filter, which could be implemented by changing the “Opacity” attribute of the XPS elements or wrapping the contents of the page with a canvas that has the “Opacity” set to a lower value;
5) Text only filter, which locates and replaces all the pictures and drawing with a place holder (e.g., a rectangular box), outputting the text elements unchanged; and
6) OCR filter, which locates and performs OCR on the image (of text) elements.

In another case, it may be desired to transform text data within a document. For example, a possible enhancement/transformation feature includes performing a spell-check on text data within document 302, and correcting the misspelled text. In addition, a possible enhancement/transformation feature includes performing a find and replace of certain text within document 302. Of course, it should be understood that transformation of text data is not limited to these examples. In addition, the parameters for transforming document 302 can be used to effect transformation of both text and image data within document 302.

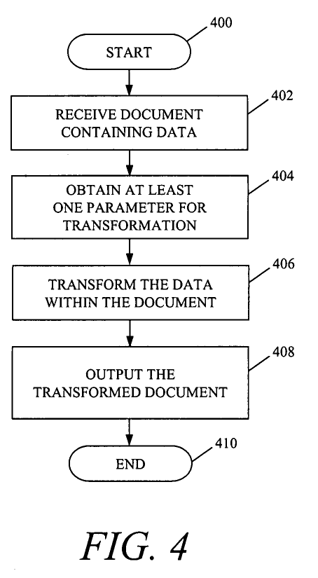

FIG. 4 is a flowchart illustrating transformation of a document containing data, according to a representative embodiment of the present invention. Following start bubble 400, a document containing data is received (block 402). The document can be received as an XPS document. Alternatively, the document can be received as a non-XPS document, which is in turn converted to an XPS.

At least one parameter is obtained for transforming the data within the document (block 404), using a print driver interface. The print driver interface can be a user interface configured to obtain the at least one parameter from a user.

The data within the document is transformed, using a filter pipeline, based on the obtained at least one parameter (block 406). The filter pipeline preferably executes at least one filter for transforming the data within the document based on the obtained at least one parameter. The filter pipeline can be a Microsoft Vista® filter pipeline. In such a case, the at least one filter can use an IXpsDocumentProvider Interface, which is included within the MS Vista® filter pipeline, to access the obtained at least one parameter and to access the document containing the data.

The data within the document can be image data, wherein the at least one filter is an image transformation filter. The data within the document can also be text data, wherein the at least one filter is a text transformation filter. In addition, both image and text data within the same document can be transformed, using at least one image transformation filter and at least one text transformation filter.

The transformed document is then output (block 408). The transformed document is preferably output as an XPS document. The process then ends (end bubble 410).

As such, an enhancement/transformation feature can be viewed as a plug-in to be used within virtually any editing software application. The feature can be applied to data within a document from the software application, even if that application does not incorporate the feature into its software.

The invention has been described above with respect to particular illustrative embodiments. It is understood that the invention is not limited to the above-described embodiments and that various changes and modifications may be made by those skilled in the relevant art without departing from the spirit and scope of the invention.

What is claimed is:

1. A method for transforming a document containing data using a filter pipeline, the method comprising the steps of:
receiving the document;
obtaining, by a print driver interface, at least one parameter for transforming the data within the document;
transforming, using the filter pipeline, the data within the document based on the obtained at least one parameter; and
outputting the transformed document.

2. A method according to claim 1, wherein the filter pipeline executes at least one filter for transforming the data within the document based on the obtained at least one parameter.

3. A method according to claim 2, wherein the filter pipeline is a Microsoft Vista® filter pipeline.

4. A method according to claim 3, wherein the at least one filter uses an IXpsDocumentProvider Interface, which is included within the MS Vista® filter pipeline, to access the obtained at least one parameter and to access the document containing the data.

5. A method according to claim 1, wherein the print driver interface is a user interface configured to obtain the at least one parameter from a user.

6. A method according to claim 1, wherein the document is received in said receiving step as an XML Page Specification (XPS) document.

7. A method according to claim 1, wherein the document is received in said receiving step as a non-XPS document, which is converted to an XPS document before being transformed.

8. A method according to claim 1, wherein the transformed document is output in said outputting step as an XPS document.

9. A method according to claim 2, wherein the data within the document is image data, and wherein the at least one filter is an image transformation filter.

10. A method according to claim 2, wherein the data within the document is text data, and wherein the at least one filter is a text transformation filter.

11. A print driver for use in a print system which includes a receiver for receiving a document containing data, a filter pipeline and an output unit, the print driver for transforming the document using the filter pipeline, the printer driver comprising:
a print driver interface for obtaining at least one parameter for transforming the data within the document; and
at least one filter for transforming the data within the document using the filter pipeline, based on the obtained at least one parameter,
wherein the output unit outputs the transformed document.

12. A print driver according to claim 11, wherein the filter pipeline executes at least one filter for transforming the data within the document based on the obtained at least one parameter.

13. A print driver according to claim 12, wherein the filter pipeline is a Microsoft Vistas filter pipeline.

14. A print driver according to claim 13, wherein the at least one filter uses an IXpsDocumentProvider Interface, which is included within the MS Vista® filter pipeline, to access the obtained at least one parameter and to access the document containing the data.

15. A print driver according to claim 11, wherein the print driver interface is a user interface configured to obtain the at least one parameter from a user.

16. A print driver according to claim 11, wherein the document is received by said receiver as an XML Page Specification (XPS) document.

17. A method according to claim 11, wherein the document is received by said receiver as a non-XPS document, which is converted to an XPS document before being transformed.

18. A print driver according to claim 11, wherein the transformed document is output by said output unit as an XPS document.

19. A print driver according to claim 12, wherein the data within the document is image data, and wherein the at least one filter is an image transformation filter.

20. A print driver according to claim 12, wherein the data within the document is text data, and wherein the at least one filter is a text transformation filter.
